(19) United States
(12) Patent Application Publication
(10) Pub. No.: US 2004/0003903 A1
(43) Pub. Date: Jan. 8, 2004

(54) Extruded rigid plastic storm shutter slat having a co-extruded rigid foam core

(75) Inventors: Brian A. Wenrick, New Carlisle, OH (US); Jeffrey S. Bull, Centerville, OH (US); Steven R. Hanauer, Dayton, OH (US); Jack D. Young, Dayton, OH (US)

Correspondence Address: Alan F. Meckstroth, JACOX, MECKSTROTH & JENKINS, Suite 2, 2310 Far Hills Building, Dayton, OH, 45419-1575, US

(73) Assignee: Creative Extruded Products, Inc.

(21) Appl. No.: 10/329,919

(22) Filed: Dec. 27, 2002

Related U.S. Application Data
(63) Continuation-in-part of application No. 29/163,462, filed on Jul. 8, 2002, now Pat. No. D472328.
Application No. 29/163,462 is a continuation-in-part of application No. 29/163,463, filed on Jul. 8, 2002, now Pat. No. D472332.

(51) Int. Cl. E06B 3/20

(52) U.S. Cl. 160/236

(57) ABSTRACT

A storm shutter slat includes an extruded body of a substantially rigid plastics material, and the body has opposite inner and outer side walls integrally connected by longitudinally extending transverse walls including spaced internal webs and opposite edge walls forming longitudinally extending hook portions and an undercut recess. The hook portions and recess provide for pivotally connecting the slat with adjacent slats and for rolling the connected slats into a coil. The extruded plastic body has a co-extruded core of substantially rigid plastics foam material which adheres or bonds to the walls of the body to provide the slat with a high bending strength, high durability against an impact, light weight and thermal insulation.

### BACKGROUND OF THE INVENTION

This invention relates to storm slats used for producing roll-up hurricane or storm shutters, for example, of the general type disclosed in U.S. Pat. No. 5,611,383, the disclosure of which is herein incorporated by reference. The storm slats are commonly made from an aluminum extrusion or an extrusion of rigid plastics material such as rigid polyvinylchloride and include inner and outer arcuate side walls which are integrally connected by longitudinally extending internal webs and longitudinally extending edge walls. The edge walls form longitudinally extending hook portions and an undercut cavity or recess which form pivotal connections with adjacent slats so that the connected slats may be rolled up into a coil as shown in the above '383 patent. Other forms of shutter slats are disclosed in U.S. Pat. Nos. 4,690,193, No. 4,972,894, No. 5,474,118 and No. 5,839,493, and published PCT patent application No. WO87/03641.

When it is desired to construct a roll-up shutter having maximum strength and resistance to high storm or hurricane winds, the slats are made from aluminum extrusions which may have telescoping reinforcement sections such as disclosed in connection with FIG. 7 of above-mentioned U.S. Pat. No. 4,690,193. The slats may also be made in interfitting half sections, and insulating foam may be inserted after the sections are connected or extruded, as disclosed in above-mentioned U.S. Pat. No. 4,972,894 and the PCT patent application. However, it has been found that aluminum shutter slats are not only expensive but are subject to corrosion due to salt water. When the aluminum slats are painted for appearance, the paint is subject to scratching, and the aluminum walls are subject to denting. The insertion of insulating foam into a shutter slat after it has been formed also presents problems and adds significantly to the cost of the slat.

### SUMMARY OF THE INVENTION

The present invention is directed to an improved storm shutter slat which may be efficiently produced and provides for a substantially high strength/weight ratio in addition to resistance to corrosion, denting and scratching. The shutter slat may also be economically produced, does not require painting and provides significant thermal insulation.

In accordance with a preferred embodiment of the invention, a shutter slat has an elongated body formed by an extrusion of substantially rigid plastics material such as rigid polyvinylchloride. The body has slightly arcuate opposite side walls which are integrally connected by longitudinally extending transverse walls to define at least one internal chamber. The transverse walls include internal webs and opposite edge walls which extend to form an integral hook portion and an undercut recess for pivotally connecting the body to the body of an adjacent slat. The slat of the invention also has a core of rigid plastics foam material which is co-extruded with the body so that the core material adheres or bonds to the inner surfaces of the body and has a uniform density along the length of the slat. Preferably, the outer side wall of the body has longitudinally extending grooves which align with the internal webs and provides a decorative outer appearance for the slat.

Other features and advantages of the invention will be apparent from the following description, the accompanying drawing and the appended claims.

### BRIEF DESCRIPTION OF THE DRAWING

FIG. 1 is a perspective view of a storm shutter slat constructed in accordance with the invention and with a center portion broken away to show that the slat may have any selected length; and

FIG. 2 is an end view of the slat shown in FIG. 1.

### DESCRIPTION OF THE PREFERRED EMBODIMENT

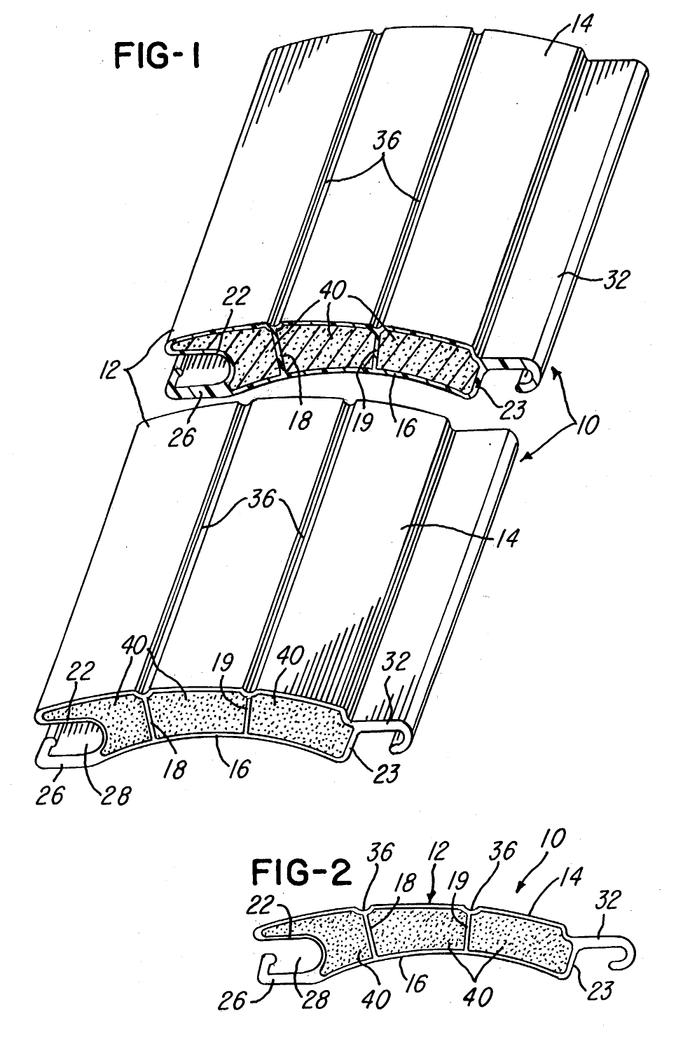

FIG. 1 shows a storm shutter slat 10 having an elongated body 12 formed from an extrusion of substantially rigid plastics material such as rigid polyvinylchloride (PVC). The extruded body 12 includes a slightly arcuate outer side wall 14 and a slightly more arcuate inner side wall 16 which are integrally connected by transverse walls including transverse webs 18 and 19 and transverse longitudinal edge walls 22 and 23. An integral hook portion or member 26 projects laterally from the J-shaped edge wall 22 and cooperates with the edge wall 22 to define a longitudinally extending undercut recess 28. Another integral hook portion or member 32 projects from the opposite transverse edge wall 23, and both of the hook portions 26 and 32 have a thickness substantially greater than the thickness of the side walls 14 and 16 and the edge walls 22 and 23.

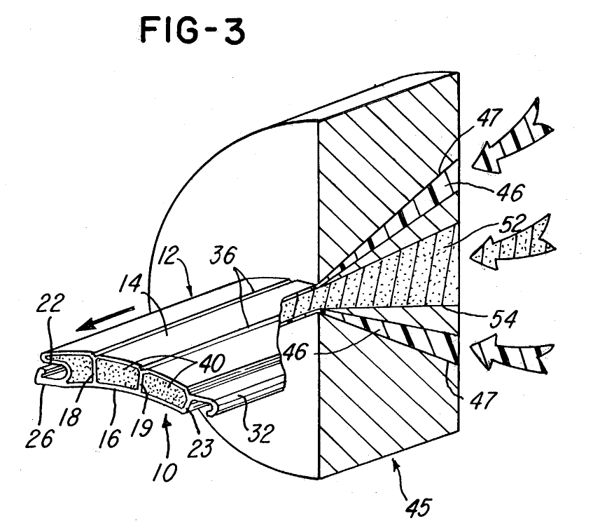

The hook portion 32 is adapted to hook into and be received by the undercut recess 28 of an adjacent slat 10, either by an articulated hooking action or a longitudinally telescoping action. As also shown in FIGS. 1 and 2, the outer side wall 14 is extruded with a plurality of longitudinally extending U-shaped grooves 36 which are longitudinally aligned with the corresponding internal transverse walls or webs 18 and 19. The grooves 36 provide a decorative appearance to the outer side wall 14 and avoid any sink marks due to the webs 18 and 19 having a thickness substantially the same as the thickness of the side walls 14 and 16.

The slat 10 has a core 40 of substantially rigid foam material, such as rigid PVC foam, and the foam material is co-extruded with the extrusion of the body 12, as shown in FIG. 3. As a result of the co-extrusion, the foam core 40, which has a uniform density substantially lower than the density of the body 12, adheres or bonds to the inner surfaces of the body 12 and fills all of the cavities or chambers on opposite sides of the webs 18 and 19. Preferably, the rigid foam core 40 has a density of about 40 pounds per cubic foot and the body 12 has a density of about 90 pounds per cubic foot. Referring to FIG. 3, the slat 10 is extruded from a co-extrusion die 45 wherein the rigid PVC material 46 forming the body 12, flows under pressure through passges 47, and the PVC foam material 52 forming the core 40, flows under pressure through the central passage 54.

As a result of the rigid foam core 40 and the adhesion or bonding of the core material 52 to the inner surfaces of the body 12, the slat 10 has a bending strength which is substantially greater than the bending strength of the extruded vinyl body 12 without the foam core 40. Thus the foam core provides for a high strength/weight ratio in addition to providing the side walls 14 and 16 with a high resistance to denting from an impact. The slat 10 will also not corrode when exposed to salt water, and the PVC material 46 forming the body 12 may be compounded to provide a high resistance to ultraviolet rays. While the body 12 may be extruded in various selected colors, the body may be also provided with a thin cap stock, especially to provide for permanent darker colors. It is also apparent that the foam core 40 provides the slat 10 with significant thermal insulation which is desirable in some installations. In addition, the co-extrusion provides for efficient and economical production in order to minimize the costs of the slat 10.

While the form of storm slat herein described and its method of production constitute a preferred embodiment of the invention, it is to be understood that the invention is not limited to the precise form of slat described, and that changes may be made therein without departing from the scope and spirit of the invention as defined in the appended claims.

What is claimed is:

1. A storm shutter slat comprising an extrusion of substantially rigid plastics material forming an elongated body including inner and outeropposite side walls integrally connected by longitudinally extending transverse walls to define at least one internal chamber, a longitudinally extending hook member and a longitudinally extending recess along opposite edges of said body for pivotally connecting said slat to at least one adjacent said slat, said body enclosing a coextruded core of substantially rigid plastics foam material extending within said chamber between said side and transverse walls and adhered to said walls, and said co-extruded core of plastics foam material cooperating with said body for substantially increasing the bending strength, durability and thermal insulation of said slat while minimizing the weight of said slat.

2. A shutter slat as defined in claim 1 wherein said transverse walls include at least one longitudinally extending internal web integrally connecting said opposite side walls and forming separate chambers on opposite sides of said web, and said co-extruded core of rigid foam material fills each of said chambers and is adhered to opposite side surfaces of said web.

3. A shutter slat as defined in claim 2 wherein said outer side wall includes at least one longitudinally extending groove substantially aligned with said web.

4. A shutter slat as defined in claim 1 wherein said outer side wall includes a plurality of longitudinally extending and parallel spaced grooves.

5. A shutter slat as defined in claim 1 wherein said body comprises a substantially rigid polyvinylchloride material.

6. A shutter slat as defined in claim 1 wherein said co-extruded core comprises a substantially rigid polyvinylchloride foam material.

7. A shutter slat as defined in claim 1 wherein said transverse walls include a plurality of longitudinally extending and spaced internal webs integrally connecting said opposite side walls and cooperating to form at least three chambers on opposite sides of said webs, and said co-extruded core of foam material fills said three chambers and is adhered to opposite side surfaces of each said web.

8. A shutter slat as defined in claim 7 wherein said outer side wall includes a corresponding plurality of longitudinally extending grooves substantially aligned with the corresponding said internal webs.

9. A storm shutter slat comprising an extrusion of substantially rigid plastics material forming an elongated body including inner and outer opposite side walls integrally connected by longitudinally extending transverse walls, said transverse walls including a plurality of longitudinally extending and spaced internal webs integrally connecting said opposite side walls and cooperating to form at least three chambers on opposite sides of said webs, said transverse walls including a longitudinally extending hook member and defining a longitudinally extending recess along opposite edges of said body for pivotally connecting said slat to at least one adjacent said slat, said body enclosing a coextruded core of substantially rigid plastics foam material extending within said chambers between said side and transverse walls and adhered to said walls, and said co-extruded core of plastics foam material cooperating with said body for substantially increasing the bending strength, durability and thermal insulation of said slat while minimizing the weight of said slat.

10. A shutter slat as defined in claim 9 wherein said outer side wall includes a plurality of longitudinally extending and parallel spaced grooves substantially aligned with said webs

11. A shutter slat as defined in claim 9 wherein said body comprises a substantially rigid polyvinylchloride material.

12. A shutter slat as defined in claim 9 wherein said core comprises a substantially rigid polyvinylchloride foam material.

13. A method of making a storm shutter slat comprising the steps of extruding a substantially rigid plastics material to form an elongated body including inner and outer opposite side walls integrally connected by longitudinally extending transverse walls to define at least one internal chamber, forming a longitudinally extending hook member and a longitudinally extending recess on the transverse walls along opposite edges of said body for pivotally connecting the slat to at least one adjacent slat, co-extruding within the body chamber a co-extruded core of substantially rigid plastics foam material with the foam material adhering to the walls, and cooling the materials causing the co-extruded core of plastics foam material to cooperate with the body for substantially increasing the bending strength, durability and thermal insulation of the slat while minimizing the weight of the slat.

14. A method as defined in claim 13 wherein one of the transverse walls is extruded as a longitudinally extending internal web integrally connecting the opposite side walls and to form separate chambers on opposite sides of the web, and co-extruding the co-extruded core of rigid foam material to fill each of the chambers and with the foam material adhering to opposite side surfaces of the web.

15. A method as defined in claim 14 including the step of extruding at least one longitudinally extending groove within the outer side wall and with the groove substantially aligned with the web.

16. A method as defined in claim 13 wherein the outer side wall is extruded with a plurality of longitudinally extending and parallel spaced grooves.

17. A method as defined in claim 13 wherein the body is extruded from a polyvinylchloride material.

18. A method as defined in claim 13 wherein the core is extruded from a polyvinylchloride foam material.

19. A method as defined in claim 13 wherein the transverse walls are extruded to form a plurality of longitudinally extending and spaced internal webs integrally connecting the opposite side walls and cooperating to form at least three chambers on opposite sides of the webs, and the co-extruded core of foam material is extruded to fill the three chambers and to adhere to opposite side surfaces of each web.
